(19) United States
(12) Patent Application Publication
(10) Pub. No.: US 2006/0149504 A1
(43) Pub. Date: Jul. 6, 2006

(54) System and method for testing liquid crystal displays

(75) Inventors: Kuan-Hong Hsieh, Tu-Cheng (TW); Zhong-Wu Tian, Shenzhen (CN); Xin Lu, Shenzhen (CN); Xiao-Guang Li, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/189,939

(22) Filed: Jul. 26, 2005

(30) Foreign Application Priority Data
Dec. 30, 2004 (CN) 200410091942.1

(51) Int. Cl. G21C 17/00

(52) U.S. Cl. 702/183

(57) ABSTRACT

A system for testing Liquid Crystal Displays (LCDs), includes: a controlling computer, an encoder, an IR transmitter, an IR receiver, and a decoder. The controlling computer is for transmitting a test instruction. The encoder is for receiving the test instruction via a port, and encoding the test instruction into an infrared (IR) signal. The IR transmitter is for transmitting the IR signal. The IR receiver is for receiving the IR signal. The decoder is for decoding the IR signal into a Visual Graphic Array (VGA) signal, and transmitting the VGA signal via a VGA port. A related method for testing LCDs is also provided.

### BACKGROUND OF THE INVENTION

1. Field of the Invention

The present invention relates generally to systems and methods for testing Liquid Crystal Displays (LCDs), and particularly to a system and method for testing LCDs by connecting a controlling terminal and a testing terminal through an infrared (IR).

2. Prior Art

In the LCD testing process, there are a lot of parameters to be tested such as contrast, the range of visual angle, responsive time, chrominance and lightness. Because there are different parameters for an LCD and according to the parameter's similitude they can be classified several classes, and each class's items need to be tested in one station, so there are at least one station needed in the LCD testing process. The LCD would flow to the next station for other parameters testing when all the present station's parameters have been performed. The connection between the LCD and the station must be cut when the LCD flows to the next station and the LCD need a new connection to the station when it flows to the next station. In the conventional testing method, the controlling terminal and the testing terminal are connected by wire. When the new LCD flows to the present station, there need an operator to connect the wire to the controlling station, and when the present station's testing are finished, the operator should cut the connection between the controlling terminal and the testing terminal. Because the conventional method need a person specially assigned for performing the cut/cut in action that wastes manpower and time, which makes low efficiency and the repeated cut/cut in action could easy cause the damage of the port.

What is needed is an system and method for connecting the controlling terminal and the testing terminal by wireless which can overcome the above-described problems.

### SUMMARY OF THE INVENTION

A system for testing Liquid Crystal Displays (LCDs) in accordance with a preferred embodiment includes: a controlling computer for transmitting a test instruction; an encoder for receiving the test instruction via a port, and encoding the test instruction into an infrared (IR) signal; an IR transmitter for transmitting the IR signal; an IR receiver for receiving the IR signal; and a decoder for decoding the IR signal into a Visual Graphic Array (VGA) signal, and transmitting the VGA signal via a VGA port.

A method for testing LCDs is also disclosed. The method includes the steps of: (a) providing a controlling computer to send a test instruction; (b) providing an encoder to receive the test instruction via a port, and encode the test instruction into an infrared (IR) signal; (c) providing an IR transmitter to transmit the IR signal; (d) providing an IR receiver to receive the IR signal; (e) providing a decoder to decode the IR signal into a Visual Graphic Array (VGA) signal, and transmitting the VGA signal via a VGA port; and (f) performing a test item on one of the LCDs to be tested corresponding to the VGA signal.

Other advantages and novel features will be drawn from the following detailed description of the embodiment with reference to the attached drawings, in which:

### BRIEF DESCRIPTION OF THE DRAWINGS

FIG. 1 is a schematic diagram of hardware infrastructure of a system for testing LCDs in according with a preferred embodiment of the present invention;

FIG. 2 illustrates two exemplary lists and synchronously illustrates a mapping relationship between the two lists;

FIG. 3 is a flowchart of a preferred method for implementing the system of FIG. 1.

### DETAILED DESCRIPTION OF THE EMBODIMENTS

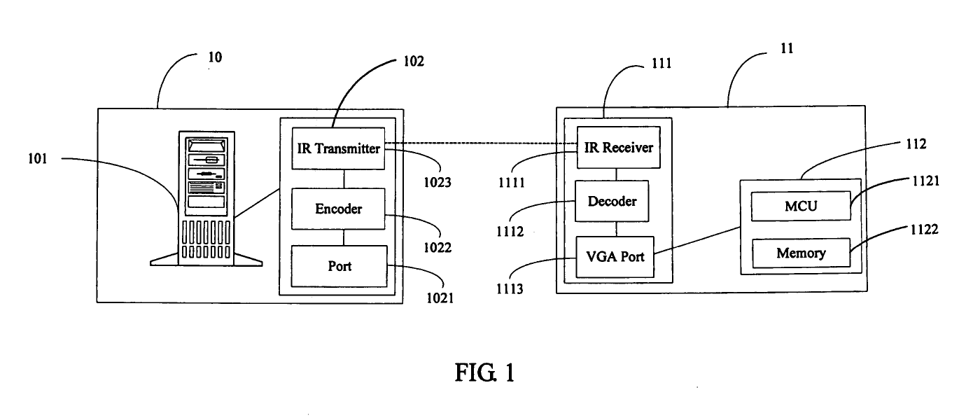

FIG. 1 is a schematic diagram of hardware infrastructure of a system for testing Liquid Crystal Displays (LCDs) (hereafter, “the system”) in accordance with a preferred embodiment of the present invention. In the preferred embodiment, there are different test items for an LCD, such as a saving power test, a power on/off test, a color temperature test, a picture display test, and so on. In order to conveniently and efficiently control test results, the test items can be classified into a plurality of groups according to test requirements, each group corresponding to a test station. Therefore, there are a plurality of test stations for testing the LCD. For simplicity, the preferred embodiment will be described with regard to one test station.

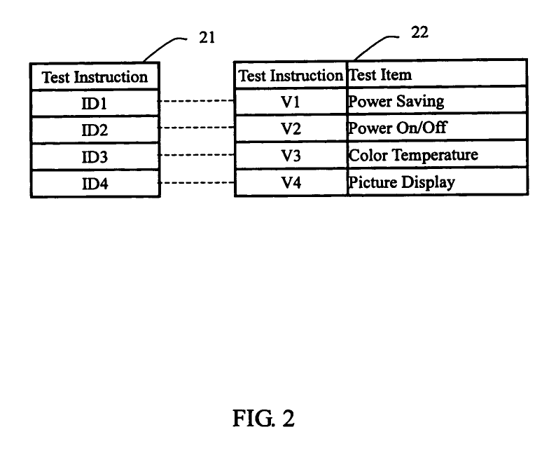

In this embodiment, the system includes a controlling terminal 10 and a test terminal 11. The controlling terminal 10 is used for controlling to test an LCD 112. The controlling terminal 10 includes a controlling computer 101 and a transmitting unit 102. The controlling computer 101 is used for obtaining test instructions from a test instruction list 21 (described in FIG. 2 below) thereof, transmitting the test instructions to the transmitting unit 102, and receiving corresponding test results from the test terminal 11. The transmitting unit 102 is for transmitting the test instructions to the test terminal 11. The transmitting unit 102 includes a port 1021, an encoder 1022, and an Infrared (IR) transmitter 1023. The port 1021 is connected with a port of the controlling computer 101 (not shown). The port 1021 may be a communication (COM) port or a Universal Serial Bus (USB) port. The encoder 1022 is provided for encoding the test instructions into an infrared signal, and transmitting the infrared signal to the IR transmitter 1023. The IR transmitter 1023 transmits the infrared signal to the testing terminal 11.

The testing terminal 11 is for receiving the infrared signal, and testing the LCD 112 according to the infrared signal. The testing terminal 11 includes a receiving unit 111 and the LCD 112. The receiving unit 111 is used for receiving the infrared signal, decoding the infrared signal into a Visual Graphic Array (VGA) signal, and transmitting the VGA signal to the LCD 112. The receiving unit 111 includes an IR receiver 1111, a decoder 1112 and a Visual Graphic Array (VGA) port 1113. The IR receiver 1111 receives the infrared signal, and transmits the infrared signal to the decoder 1112. The decoder 1112 decodes the infrared signal into a VGA signal, and transmits the VGA signal to the LCD 112 via the VGA port 1113. As receiving the VGA signal, the LCD 112 performs corresponding test items. The LCD 112 includes a Microprogrammed Control Unit (MCU) 1121 and a memory 1122. The memory 1122 stores a test item list 22 described in FIG. 2 below. The MCU 1121 searches the corresponding test items in the test item list 22 according to the VGA signals, and performs the test items.

FIG. 2 illustrates two exemplary lists: the test instruction list 21 and the test item list 22, and synchronously illustrates a mapping relationship between the two lists. The test instruction list 21 includes one column (i.e., test instruction) for recording test instructions, each of which is designated a corresponding ID (symbolically depicted as ID1, ID2, ID3, ID4, and so on.) The test item list 22 includes two columns (i.e., test instruction and test item) for recording test instructions and corresponding test items. Similarly, each test instruction of the test item list 22 is designated an ID (symbolically depicted as V1, V2, V3, V4, and so on) for mapping with the test instruction of the test instruction list 21, further more, is designated a test item (e.g., saving power, power on/off, color temperature, picture display, and so on).

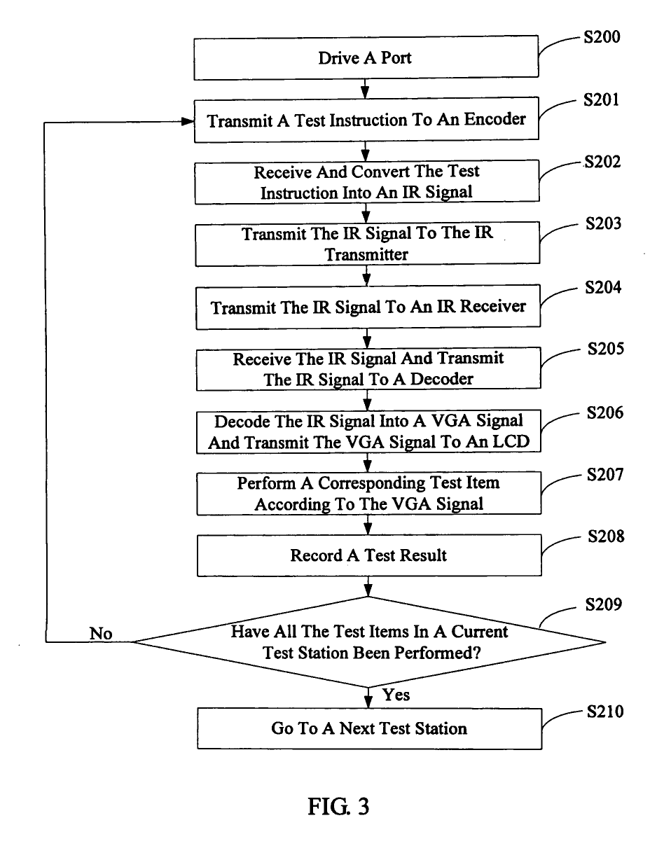

FIG. 3 is a flowchart of a preferred method for testing LCDs by utilizing the above-described system. In step S200, the controlling computer 101 drives the port 1021 via corresponding driving programs. In step S201, the controlling computer 101 transmits a test instruction to the encoder 1022 via the port 1021. In step S202, the encoder 1022 receives the test instruction, and converts the test instruction into an IR signal. In step S203, the encoder 1022 transmits the IR signal to the IR transmitter 1023. In step S204, the IR transmitter 1023 transmits the IR signal to the IR receiver 1111. In step S205, the IR receiver 1111 receives the IR signal, and transmits the IR signal to the decoder 1112. In step S206, the decoder 1102 decodes the IR signal into a VGA signal, and transmits the VGA signal to the LCD 112 via the VGA port 1113. In step 207, the MCU 1121 searches for a test item in the memory 1122 according to the VGA signal, and performs the test item. In the step S208, the controlling computer 101 records the test result. In the step S209, the controlling computer 101 determines whether all test items in a current test station have been performed. If all the test items have been performed, in step 210, the LCD 112 goes to a next test station. In contrast, if any one of the test items has not been performed, the procedure returns to step 201 described-above.

Although the present invention has been specifically described on the basis of a preferred embodiment and preferred method, the invention is not to be construed as being limited thereto. Various changes or modifications may be made to the embodiment and method without departing from the scope and spirit of the invention.

We claim:

1. A system for testing Liquid Crystal Displays (LCDs), the system comprising:
a controlling computer for transmitting a test instruction;
an encoder for receiving the test instruction via a port, and encoding the test instruction into an infrared (IR) signal;
an IR transmitter for transmitting the IR signal;
an IR receiver for receiving the IR signal; and
a decoder for decoding the IR signal into a Visual Graphic Array (VGA) signal, and transmitting the VGA signal via a VGA port.

2. The system described as in claim 1, wherein each of the LCDs to be tested performs a test item according to the VGA signal.

3. The system described as in claim 2, wherein the controlling computer receives test result corresponding to the test item and records the test result.

4. The system described as in claim 1, wherein the port is a Universal Serial Bus (USB) port or a Communication (COM) port.

5. The system described as in claim 2, wherein each of the LCDs to be tested comprises a Microprogrammed Control Unit (MCU) for receiving the VGA signal and performing the test item, and a memory for storing a list which records test instructions and corresponding test items.

6. A method for testing Liquid Crystal Displays (LCDs), the method comprising the step of:
providing a controlling computer to send a test instruction;
providing an encoder to receive the test instruction via a port, and encode the test instruction into an infrared (IR) signal;
providing an IR transmitter to transmit the IR signal;
providing an IR receiver to receive the IR signal;
providing a decoder to decode the IR signal into a Visual Graphic Array (VGA) signal, and transmitting the VGA signal via a VGA port; and
performing a test item on one of the LCDs to be tested corresponding to the VGA signal.

7. The method described as in claim 6, wherein each of the LCDs comprises a Microprogrammed Control Unit (MCU) for receiving the VGA signal, and performing the test item corresponding to the VGA signal, and a memory for storing a list which records test instructions and corresponding test items.

8. The method described as in claim 7, further comprising the step of searching for the test item in the memory according to the VGA signal.

9. The method described as in claim 6, further comprising the steps of determining whether all test items in a current test station for the LCD have been performed, and going to a next test station if all test items have been performed.

10. The method described as in claim 9, further comprising the step of performing a next test item if any one of the test items in the current test station has not been performed.

11. A method for testing display devices, comprising the step of:
presetting test instructions for testing display devices in a controlling computer;
presetting testing items corresponding to said test instructions in a testing terminal capable of performing selective ones of said testing items on said display devices; and
transmitting user-selected test instructions from said controlling computer to said testing terminal by means of wireless transmission so as to initiate performing said selective ones of said testing items on said display devices according to said user-selected test instructions.

12. The method described as in claim 11, further comprising the step of generating Visual Graphic Array (VGA) signals to be transmitted to said display devices for display testing based on said user-selected test instructions transmitted to said testing terminal by said wireless transmission.

13. The method described as in claim 11, wherein said wireless transmission is infrared (IR) transmission, and said display devices are Liquid Crystal Displays (LCDs).
